(19) United States
(12) Patent Application Publication
(10) Pub. No.: US 2017/0371156 A1
(43) Pub. Date: Dec. 28, 2017

(54) VEHICULAR DISPLAY CONTROL DEVICE AND VEHICULAR DISPLAY DEVICE

(71) Applicant: MITSUBISHI ELECTRIC CORPORATION, Tokyo (JP)

(72) Inventors: Akinori HEISHI, Tokyo, Chiyoda-ku (JP); Atsushi MICHIMORI, Tokyo, Chiyoda-ku (JP); Shota NAKAHARA, Tokyo, Chiyoda-ku (JP); Jun KONDO, Tokyo, Chiyoda-ku (JP)

(73) Assignee: MITSUBISHI ELECTRIC CORPORATION, Tokyo (JP)

(21) Appl. No.: 15/543,790

(22) PCT Filed: Feb. 29, 2016
(86) PCT No.: PCT/JP2016/056071

§ 371 Date: Jul. 14, 2017

(30) Foreign Application Priority Data
Mar. 4, 2015 (JP) 2015-042430

(51) Int. Cl. G02B 27/01; H04N 5/247; B60R 1/00

(52) U.S. Cl. CPC G02B 27/0101; B60R 1/00; H04N 5/247; B60R 2300/302; B60R 2300/205; G02B 2027/0138; G02B 2027/014; B60R 2300/8026

(57) ABSTRACT

A vehicular display control device includes an image acquisition section configured to acquire a first captured image obtained by capturing a back or a side of a vehicle and a second captured image including an image obtained by a driver of the vehicle by facing to a left side or a right side with respect to a vehicle's traveling direction and a display controller configured to make a head-up display mounted on the vehicle display both of a first display image based on the first captured image and a second display image based on the second captured image on different display screens respectively.

### TECHNICAL FIELD

The present invention relates to a vehicular display control device and a vehicular display device for projecting an image captured by a camera and thereby displaying the image in front of a driver.

### BACKGROUND ART

As an example of a conventional display device for a vehicle, there is disclosed a vehicular display device that performs image transformation on an image captured by a vehicle outside image capturing camera based on the driver's face position detected from an image captured by a driver image capturing camera and a signal from an angle regulator representing a mirror angle of a virtual side mirror and makes a head-up display display the transformed image as a virtual side mirror image (see Patent Reference 1, for example).

### PRIOR ART REFERENCE

### Patent Reference

Patent Reference 1: Japanese Patent Application Publication No. 2008-141574

### SUMMARY OF THE INVENTION

### Problem to be Solved by the Invention

In such a vehicular display device, images of scenes in blind spots for the driver are captured by a lot of cameras and the captured images are displayed by a head-up display. However, at times of making a right or left turn or a lane change, for example, there is a problem that the driver gets confused since the images displayed by the conventional head-up display significantly differ from the visual field of the driver.

The object of the present invention, which has been made to resolve the above-described problem, is to provide a vehicular display control device and a vehicular display device capable of inhibiting the driver's confusion by displaying an image viewed from the driver of the vehicle with a head-up display.

### Means for Solving the Problem

A vehicular display control device according to the present invention includes an image acquisition section, an image processor, and a display controller. The image acquisition section acquires a captured image captured by an image capturing section. The captured image includes an identical image identical with an image reflected in a side mirror of a vehicle viewed from a driver. The image processor extracts the identical image from the captured image. The display controller selects an image to be displayed as a display image by a head-up display mounted on the vehicle in regard to the identical image extracted from the captured image by the image processor and also controls timing of displaying the display image.

A vehicular display device according to the present invention includes an image acquisition section that acquires a captured image captured by an image capturing section and including an identical image as an image identical with an image reflected in a vehicle's side mirror viewed from a driver, an image processor that extracts the identical image from the captured image, a display controller that makes a selection of an image to be displayed as a display image by a head-up display mounted on the vehicle in regard to the identical image extracted from the captured image by the image processor and also controls timing of displaying the display image, and a display as the head-up display that displays the display image.

A vehicular display control device according to the present invention includes an image acquisition section that acquires a captured image captured by an image capturing section arranged in a vehicle and including an image obtained by a driver by facing to a left side or right side with respect to the vehicle's traveling direction, and a display controller that makes a head-up display display the captured image as a display image.

A vehicular display device according to the present invention includes an image acquisition section that acquires a captured image captured by an image capturing section arranged in a vehicle and including an image obtained by a driver by facing to a left side or right side with respect to the vehicle's traveling direction, a display controller that makes a head-up display display the captured image as a display image, and a display as the head-up display that displays the display image.

### Effects of the Invention

In accordance with the vehicular display control device and the vehicular display device according to the present invention, an image viewed from the driver of the vehicle is displayed by a head-up display, and thus the driver's confusion can be inhibited.

### BRIEF DESCRIPTION OF THE DRAWINGS

FIG. 1 is a functional block diagram of a vehicular display device according to a first embodiment of the present invention.

FIG. 2 is a hardware configuration diagram of the vehicular display device according to the first embodiment of the present invention.

FIG. 3 shows a left side mirror of the vehicular display device according to the first embodiment of the present invention.

FIG. 4 shows side mirror camera image capturing ranges which are ranges in which the image capturing is possible by side mirror camera image capturing ranges of the vehicular display device according to the first embodiment of the present invention.

FIG. 5 shows the interior of a vehicle according to the first embodiment of the present invention.

FIG. 6 is a diagram for explaining the visual field of the driver.

FIG. 7 is a diagram showing the driver's visual fields including a side mirror.

FIG. 8 is a diagram showing ranges that the driver can recognize by using the vehicular display device according to the first embodiment of the present invention.

FIG. 9 is a flowchart of a display controller according to the first embodiment of the present invention.

FIG. 10 shows side mirror surface image capturing cameras of the vehicular display device according to the first embodiment of the present invention.

FIG. 11 is a functional block diagram of a vehicular display device according to a second embodiment of the present invention.

FIG. 12 is a diagram showing a left side mirror visual field range of the left side mirror.

FIG. 13 is a diagram showing the driver's visual field obtained when the driver faces to the left side with respect to the vehicle's traveling direction.

FIG. 14 shows in-vehicle camera image capturing ranges of the vehicular display device according to the second embodiment of the present invention.

FIG. 15 shows in-vehicle camera image capturing ranges of the vehicular display device according to the second embodiment of the present invention.

FIG. 16 shows in-vehicle camera image capturing ranges of the vehicular display device according to the second embodiment of the present invention.

FIG. 17 shows the interior of a vehicle according to the second embodiment of the present invention.

FIG. 18 is a functional block diagram of a vehicular display device according to a third embodiment of the present invention.

FIG. 19 is a flowchart of a display controller according to the third embodiment of the present invention.

FIG. 20 is a functional block diagram of a vehicular display device according to a fourth embodiment of the present invention.

FIG. 21 shows the interior of a vehicle according to the fourth embodiment of the present invention.

FIG. 22 is a flowchart of a display controller according to the fourth embodiment of the present invention.

### NODE FOR CARRYING OUT THE INVENTION

### First Embodiment

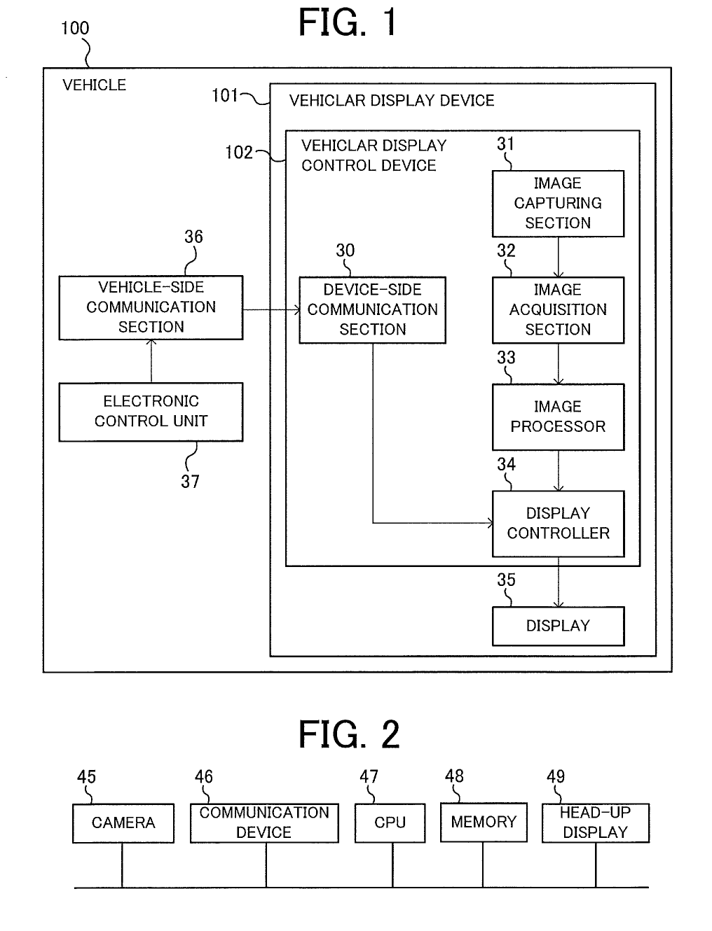

A vehicular display device 101 according to a first embodiment of the present invention will be described below with reference to FIGS. 1 to 10. Elements in the drawings with the same reference character are identical or corresponding elements and the same applies to the whole of the description.

FIG. 1 is a functional block diagram of the vehicular display device 101 according to the first embodiment of the present invention. The vehicular display device 101 and a vehicle 100 are shown in FIG. 1. The vehicle 100 is, for example, a motor vehicle such as a four-wheel vehicle or a two-wheel vehicle. The vehicular display device 101 is a device mounted on the vehicle 100 to display images.

As shown in FIG. 1, the vehicular display device 101 according to the first embodiment of the present invention includes a display 35 for displaying images and a vehicular display control device 102. The vehicular display control device 102 includes an image capturing section 31, an image acquisition section 32, an image processor 33, a display controller 34 and a device-side communication section 30. The vehicle 100 shown in FIG. 1 includes a vehicle-side communication section 36 and an electronic control unit 37.

FIG. 2 is a hardware configuration diagram of the vehicular display device 101 according to the first embodiment of the present invention. As shown in FIG. 2, the vehicular display device 101 includes a camera 45, a communication device 46, a CPU (Central Processing Unit) 47, a memory 48 and a head-up display 49. The image capturing section 31 is the camera 45, and the image acquisition section 32 and the device-side communication section 30 are the communication device 46. The display 35 is the head-up display 49 configured to project and display an image in front of the driver (e.g., the front of the driver). The operation of the image processor 33 and the display controller 34 is implemented by the CPU 47 executing a program stored in the memory 48. It is also possible to use a GPU (Graphics Processing Unit) for the implementation of the image processor 33 and the display controller 34.

The image capturing section 31 is the camera 45 attached to the vehicle 100 to capture images as captured images. In the present application, a left side mirror camera 13, a right side mirror camera 15, a left side mirror surface image capturing camera 50a and a right side mirror surface image capturing camera 50b are shown as an example of the camera 45 of the image capturing section 31 in the first embodiment. In a second embodiment described later, in-vehicle cameras 61a-61e provided in the vehicle (FIGS. 14 to 16) will be shown as an example of the camera 45 of the image capturing section 31.

The captured image is an image captured by the camera 45 and is an image including an image identical with an image viewed from the driver. Incidentally, in regard to the image including the identical image, there are cases where the image viewed from the driver and the captured image are identical images.

In the present application, the image viewed from the driver is the shape or appearance of an object displayed by refraction or reflection of light or the like via no mechanical processing and is an image obtained by the driver's own eyes. Each of an image reflected in a mirror surface part 14 or 16 of the side mirror of the vehicle 100 viewed from the driver mentioned later in the first embodiment and an image obtained by the driver by facing to the left side or right side with respect to the vehicle's traveling direction mentioned later in the second embodiment is the shape or appearance of an object displayed by refraction or reflection of light or the like via no mechanical processing and is an image obtained by the driver's own eyes.

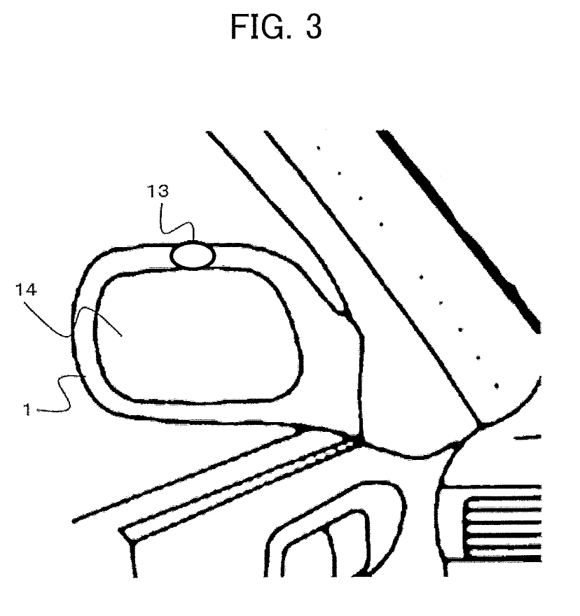

An example of the installation position of the left side mirror camera 13, as the image capturing section 31 provided on a left side mirror 1, is shown in FIG. 3. FIG. 3 shows the left side mirror 1 of the vehicle 100 according to the first embodiment of the present invention. The left side mirror camera 13 is provided on the upper part of the left side mirror 1 indicated by the filled circle.

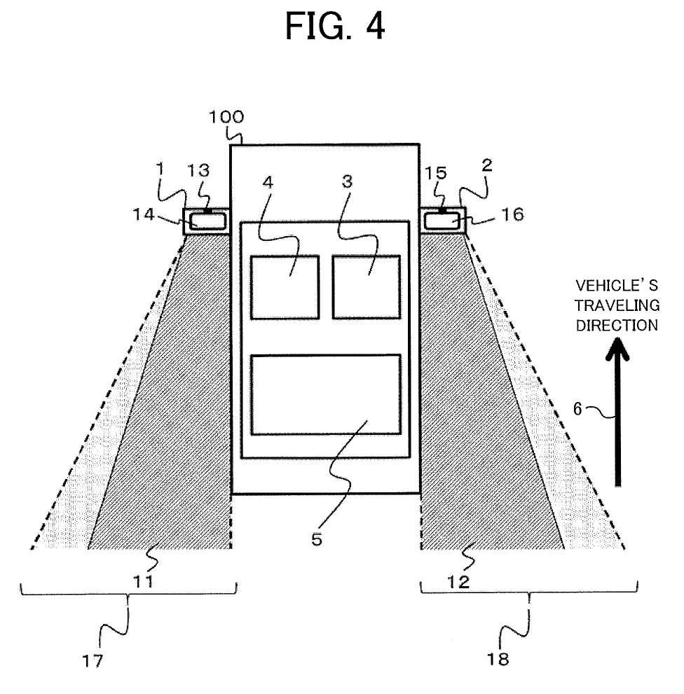

Image capturing ranges in which the left side mirror camera 13 and the right side mirror camera 15 as the image capturing section 31 are capable of capturing images will be explained by using FIG. 4. FIG. 4 shows side mirror camera image capturing ranges 17 and 18 as ranges in which the image capturing is possible by the side mirror camera image capturing ranges 13 and 15 of the vehicular display device 101 according to the first embodiment of the present invention. In the vehicle 100 shown in FIG. 4, the front right side with respect to the vehicle's traveling direction 6 is a driver seat 3, the front left side with respect to the vehicle's traveling direction 6 is a passenger seat 4, and the rear side with respect to the vehicle's traveling direction 6 is a rear seat 5. The driver seat 3 and the passenger seat 4 may be interchanged depending on the model of the car. The hatched part in FIG. 4 on the left side with respect to the vehicle's traveling direction 6 is a left side mirror visual field range 11 which is a range reflected in a mirror surface part 14 of the left side mirror viewed from the driver of the vehicle 100. Similarly, the hatched part in FIG. 4 on the right side with respect to the vehicle's traveling direction 6 is a right side mirror visual field range 12 which is a range reflected in a mirror surface part 16 of the right side mirror viewed from the driver of the vehicle 100.

By using a camera having a short focal length and a wide field angle as the side mirror camera 13 or 15, for example, it is possible to capture an image of a wider range than the image reflected in the mirror surface part 14 or 16 of a side mirror viewed from the driver of the vehicle 100. For example, the image capturing range of the left side mirror camera 13 is a range including the left side mirror visual field range 11 and allowing for the image capturing of the hatched part and the dotted part in FIG. 4 on the left side with respect to the vehicle's traveling direction 6. The image capturing range of the right side mirror camera 15 is a range including the right side mirror visual field range 12 and allowing for the image capturing of the hatched part and the dotted part in FIG. 4 on the right side with respect to the vehicle's traveling direction 6.

Incidentally, the side mirror camera 13 or 15 may be adjusted and provided so as to be able to capture an image identical with the image reflected in the mirror surface part 14 or 16 of a side mirror viewed from the driver of the vehicle 100. In other words, it is possible to provide the left side mirror camera 13 so that the left side mirror camera image capturing range 17 coincides with the left side mirror visual field range 11 or to provide the right side mirror camera 15 so that the right side mirror camera image capturing range 18 coincides with the right side mirror visual field range 2.

While the left side mirror camera image capturing range 17 and the right side mirror camera image capturing range 18 actually include part of the body of the vehicle 100, the included part is not shown in FIG. 4. The same goes for drawings explained later.

Further, in the first embodiment of the present invention, the left side mirror 1 and the right side mirror 2 are side mirrors 1 and 2 using mirrors and include the mirror surface parts 14 and 16. Here, the side mirror is not limited to the conventional type of side mirror using a mirror but can also be a side mirror that is provided instead of that using a mirror, captures an image of a scene beside the vehicle 100 by a side mirror camera, and displays the captured image on a monitor (not shown). In such cases, the left side mirror camera is a camera that captures an image corresponding to the conventional left side mirror 1 using a mirror, and the right side mirror camera is a camera that captures an image corresponding to the conventional right side mirror 2 using a mirror. The monitor, for displaying an image captured by the left side mirror camera or the right side mirror camera used as the image capturing section 31, is provided separately from the head-up display 49, and may be provided in the vicinity of the left and right pillar of the windshield, for example.

Thus, the side mirrors in the present application may be either the conventional type of side mirrors 1 and 2 using mirrors or the side mirror cameras and the monitors provided instead of the conventional type of side mirrors using mirrors. With such configurations, the display controller 34 is capable of making the head-up display display an image identical with the image (the images displayed on the monitor) reflected in the side mirror of the vehicle 100 viewed from the driver.

Further, there can be cases where the side mirrors in the first embodiment of the present invention are fender mirrors.

Incidentally, the vehicular display control device 102 may include the image capturing section 31, or in cases where the vehicle 100 is previously provided with the image capturing section 31, the vehicular display device 101 may use the image capturing section 31 provided in the vehicle 100.

The image acquisition section 32, as the communication device 46, acquires the captured images captured by the image capturing section 31. The transmission of data between the image acquisition section 32 and the image capturing section 31 may be carried out either by wireless communication or wire communication.

The image processor 33 performs image processing for making the captured image acquired by the image acquisition section 32 be identical with the image viewed from the driver. In the first embodiment of the present invention, the captured image is an image including an image identical with the image reflected in the mirror surface part 14 or 16 of a side mirror viewed from the driver of the vehicle 100. The image processor 33 mainly performs image processing for extracting an image of the mirror surface part 14 or 16 of a side mirror from the captured image. Incidentally, the image processing for making the captured image be identical with the image viewed from the driver is not required to make the captured image be strictly identical with the image viewed from the driver; it is acceptable as long as the image after the image processing is an image giving the same impression to the driver as the image viewed from the driver.

The display controller 34 makes the head-up display 49 as the display 35 display a display image. In other words, the display controller 34 controls the display 35 so as to make the display 35 display the display image in front of the driver. The display image is the image displayed by the display, that is, the captured image or the image obtained by the image processor 33 by processing the captured image.

In the first embodiment of the present invention, the display controller 34 may make the head-up display 49 display a display image including an image identical with the image reflected in the mirror surface part 14 or 16 of the side mirror of the vehicle viewed from the driver of the vehicle captured by the image capturing section 31. Further, the display controller 34 may make the head-up display 49 display a display image extracted from the captured image by the image processor 33 by the image processing for making the captured image be identical with the image reflected in the mirror surface part 14 or 16 of a side mirror.

In the first embodiment of the present invention, the display 35 is the head-up display 49 configured to display the display images as images. As shown in FIG. 1, the display 35 may be provided either separately from the vehicular display control device 102 or integrally with the vehicular display control device 102

The head-up display 49 may be of the type projecting the display images onto the windshield 22 of the vehicle or the type making a combiner display the display images, but the head-up display 49 is not limited to these types. The head-up display 49 displays the display images in front of the driver (the display images are displayed on the windshield 22 in front of the driver in the first embodiment of the present invention), and thus movement of the driver's line of sight can be kept to the minimum. Further, since the head-up display 49 forms the display images 2-3 meters ahead of the vehicle, for example, the load on the driver switching the focal point in order to check the display images is lightened.

The device-side communication section 30 is the communication device 46, and transmission of data between the device-side communication section 30 and the vehicle-side communication section 36 is carried out by wireless communication or wire communication. The device-side communication section 30 receives information on the vehicle 100 from the vehicle-side communication section 36, such as steering information regarding the direction of the steering of the steering wheel 21 of the vehicle 100, gyro sensor information including information on the angle or the angular speed of the vehicle 100, and direction indicator information including information on a direction indicated by the direction indicator, for example. Incidentally, one communication device 46 may serves as both the device-side communication section 30 and the image acquisition section 32.

The vehicle-side communication section 36, as the communication device 46, acquires multiple pieces of vehicle information from a set of electronic control units 37 of the vehicle 100 via a CAN (Controller Area Network) bus (not shown).

The electronic control unit 37, which are referred to as ECU, represent microcomputers performing electric control. The ECU is an unit performing not only the control of the engine but also a wide variety of control such as the control of motors, battery, brakes, lamps, power steering, power windows, car air-conditioner and meters, and lots of ECUs are installed in the motor vehicle.

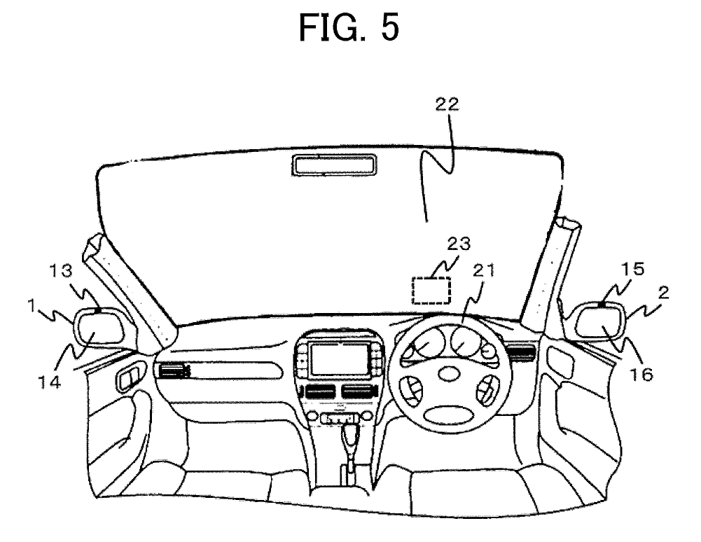

FIG. 5 shows the interior of the vehicle 100 according to the first embodiment of the present invention. As shown in FIG. 5, in the vehicular display device 101 according to the first embodiment of the present invention, the left side mirror camera 13 and the right side mirror camera 15 are provided at the positions of filled circles in the upper parts of the left side mirror 1 and the right side mirror 2 respectively. Although not shown in FIG. 5, the images viewed from the driver are reflected in the mirror surface part 14 of the left side mirror and the mirror surface part 16 of the right side mirror respectively.

The captured image captured by the left side mirror camera 13 or the right side mirror camera 15 undergoes the image processing by the image processor 33, and the display controller 34 makes the head-up display 49 project and display the processed image in front of the driver seat 3 as the display image. In FIG. 5, the display image is displayed on a display screen 23 in a lower part of the windshield 22. However, the display position is not limited to this example. Incidentally, while no image is displayed on the display screen 23 in FIG. 5, an image identical with the image reflected in the mirror surface part 14 of the left side mirror or the mirror surface part 16 of the right side mirror viewed from the driver is displayed on the display screen 23. Further, the display controller 34 is not limited to a controller which makes the head-up display 49 display only the image identical with the image reflected in the mirror surface part 14 or 16 of a side mirror; other information such as speed information on the vehicle 100 or navigation information from a navigation system may also be displayed at the same time.

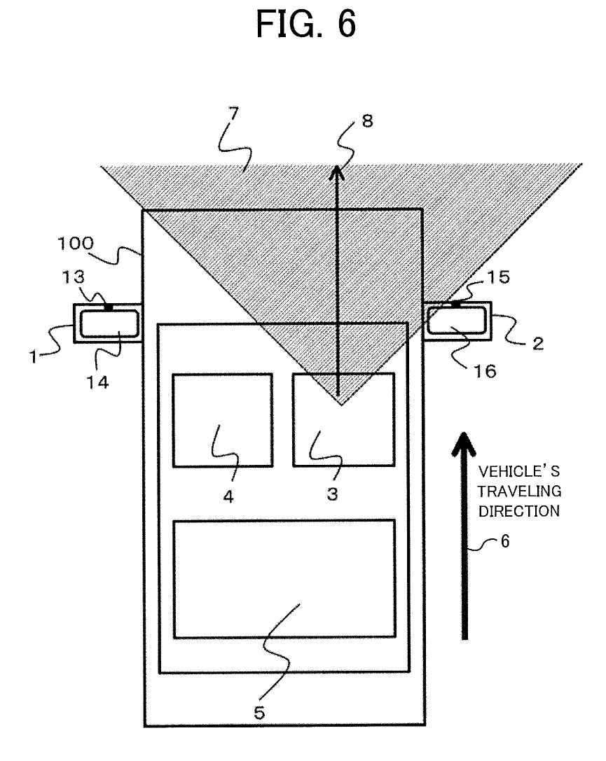

Next, the display image in the first embodiment of the present invention will be explained below along with an explanation of the visual field of the driver. FIG. 6 is a diagram for explaining the visual field 7 of the driver. As shown in FIG. 6, the driver is seated on the driver seat 3 and driving the vehicle while generally facing the vehicle's traveling direction 6. Here, the hatched part in FIG. 6 indicates the visual field 7 of the driver. In the visual field 7 of the driver, the arrow parallel to the traveling direction indicates a fixation point direction 8. The fixation point direction 8 represents the center of a human's visual field (fixation point). The resolution becomes higher and paying attention becomes easier as it comes closer to the fixation point.

The visual field 7 of the driver in the present application is assumed to be a stable field of fixation. The stable field of fixation is a visual field range that the driver's fixation point is considered to be able to view quickly and stably, which is generally said to be a range horizontally within ±45 degrees from the fixation point direction 8. Therefore, when another vehicle, an obstacle, a pedestrian or the like exists in the visual field 7 of the driver, the driver can recognize the object without much difficulty. In contrast, outside the visual field 7 of the driver, the recognition becomes vague and thus the driver cannot sufficiently acquire information necessary for driving the vehicle not to collide with another vehicle, an obstacle, a pedestrian or the like.

As shown in FIG. 6, the right side mirror 2 and the left side mirror 1 of the vehicle 100 are not included in the range of the visual field 7 of the driver. Therefore, the driver has to move the fixation point and check the right side mirror 2 or the left side mirror 1 when making a course change or a right or left turn of the vehicle 100.

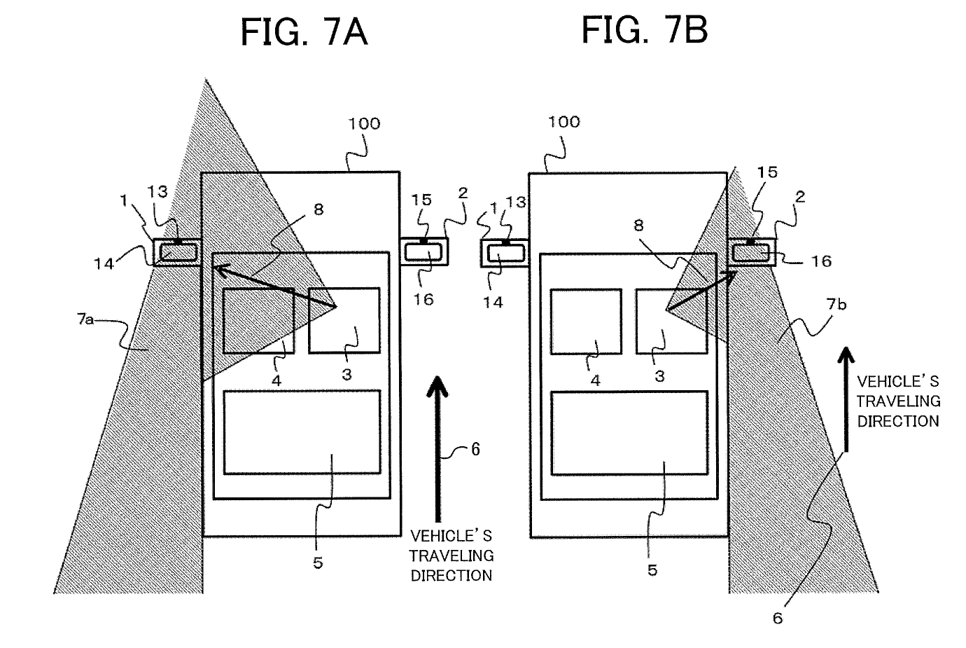

FIG. 7 is a diagram showing the visual fields of the driver including the side mirror 1 or 2. FIG. 7A shows the visual field 7a of the driver when the driver's fixation point is pointed at the left side mirror 1, while FIG. 7B shows the visual field 7b of the driver when the driver's fixation point is pointed at the right side mirror 2. The hatched part in FIG. 7A or FIG. 7B indicates the visual field 7a or 7b of the driver as the combination of a visual field obtained by the driver's own eyes and a visual field obtained from the image reflected in the mirror surface part 14 or 16 of a side mirror. Incidentally, the arrow pointing towards the left side mirror 1 in FIG. 7A and the arrow pointing towards the right side mirror 2 in FIG. 7B indicate the fixation point directions 8 of the driver.

According to FIG. 7A, when the driver watches the left side mirror 1, the driver cannot obtain a visual field in front of the driver. Similarly, according to FIG. 7B, when the driver watches the right side mirror 2, the driver cannot obtain a visual field in front of the driver. Therefore, when the driver moves the fixation point and checks the right side mirror 2 or the left side mirror 1 for making a course change or a right or left turn of the vehicle 100, the driver cannot obtain a visual field in front of the driver and thus has to make the safety check in a careful manner.

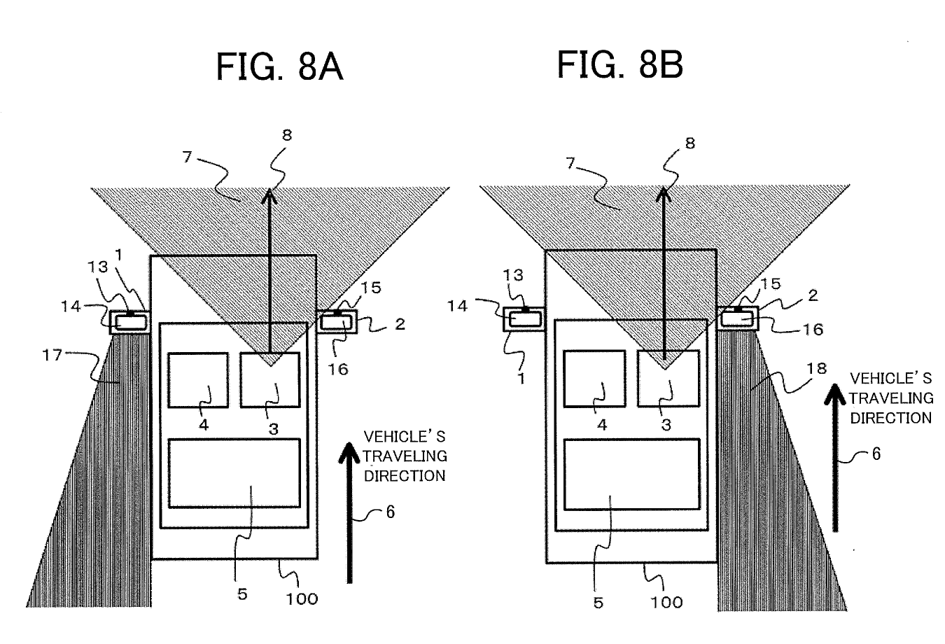

FIG. 8 is a diagram showing ranges that the driver can recognize by using the vehicular display device 101 according to the first embodiment of the present invention. FIG. 8A shows a range allowing for the image capturing by the left side mirror camera 13 and the visual field 7 of the driver that the driver can recognize with the driver's own eyes. FIG. 8B shows a range allowing for the image capturing by the right side mirror camera 15 and the visual field 7 of the driver that the driver can recognize with the driver's own eyes. Incidentally, the vertical stripes in FIG. 8A indicate the left side mirror camera image capturing range 17 and the vertical stripes in FIG. 8B indicate the right side mirror camera image capturing range 18.

In FIG. 5, an image identical with the image reflected in the mirror surface part 14 or 16 of a side mirror is displayed on the display screen 23 of the windshield 22 in front of the driver. Therefore, even when making a course change or a right or left turn of the vehicle 100, the driver can acquire the image reflected in the left side mirror 1 or the right side mirror 2 viewed from the driver without the need of moving the fixation point to the left side mirror 1 or the right side mirror 2. Accordingly, the driver can keep the fixation point direction 8 in parallel with the vehicle's traveling direction 6 even when making a course change or a right or left turn of the vehicle 100.

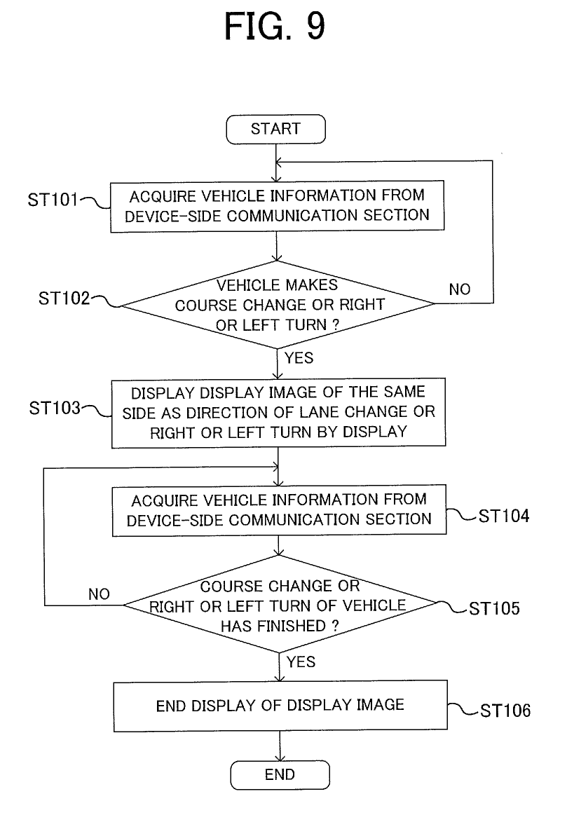

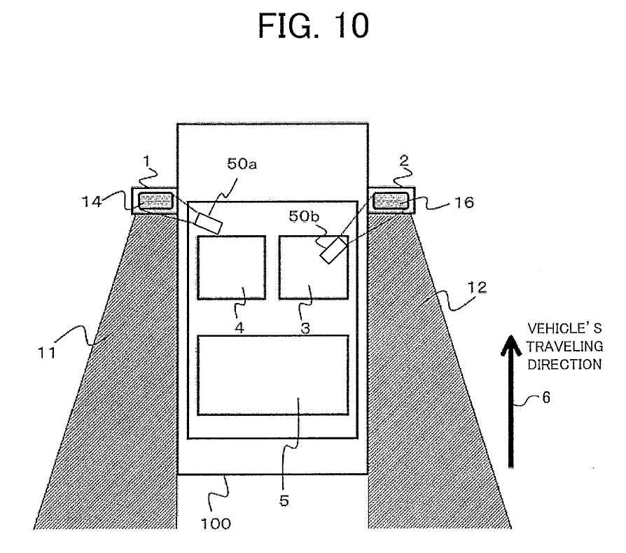

Next, the operation of the vehicular display device 101 according to the first embodiment of the present invention will be described below. FIG. 9 is a flowchart of the display controller 34 according to the first embodiment of the present invention. The flowchart of FIG. 9 may either be executed periodically or started in response to the reception of a start signal from the device-side communication section 30 by the display controller 34. In FIG. 9, the image capturing section 31 is the left side mirror camera 13 and the right side mirror camera 15, and the display 35 is the head-up display 49.

In step ST101, the display controller 34 acquires the vehicle information from the device-side communication section 30. The acquired vehicle information includes at least a piece of information selected from the steering information regarding a direction of steering of the steering wheel of the vehicle 100, the gyro sensor information including information on the angle or the angular speed of the vehicle 100, and the direction indicator information including information on a direction indicated by the direction indicator. Incidentally, the vehicle information that is acquired is not limited to these pieces of information and can include other information such as acceleration information on the vehicle.

In step ST102, the display controller 34 judges whether or not the vehicle 100 makes a course change or a right or left turn based on the vehicle information acquired in the step ST101. The process advances to step ST103 when the display controller 34 judges that the vehicle 100 makes the course change or the right or left turn, or returns to the step ST101 when the display controller 34 judges that the vehicle 100 does not make the course change or the right or left turn.

An example of the judgment on whether or not the vehicle 100 makes a course change or a right or left turn will be explained below. For example, in cases where the direction indicator information includes information on a direction indicated by the direction indicator, the display controller 34 judges that the vehicle 100 changes the lane to the left or right or turns to the left or right based on the direction indicator information. Further, in cases where the gyro sensor information includes information on an angle or an angular speed exceeding a threshold value in a left or right direction, for example, the display controller 34 judges that the vehicle 100 changes the lane to the left or right or turns to the left or right based on the gyro sensor information. Furthermore, in cases where the steering information includes information indicating a steering direction of the steering wheel and steering greater than or equal to a predetermined steering amount, for example, the display controller 34 judges that the vehicle 100 changes the lane to the left or right or turns to the left or right based on the steering information.

For example, in cases of employing a configuration in which an illuminant such as an LED is provided on a steering shaft and an optical sensor is provided on a steering shaft bearing, photoreceiving status of the optical sensor changes when the steering wheel is turned. Thus, the steering direction of the steering wheel and the steering amount of the steering wheel can be determined based on a steering signal corresponding to the photoreceiving status of the optical sensor.

Incidentally, when the display controller 34 judges in step ST102 that the vehicle 100 makes a course change or a right or left turn based on the vehicle information acquired in the step ST101, information on the direction of the course change or the right or left turn of the vehicle 100 is generally also acquired secondarily. When such information is not acquired secondarily, the display controller 34 judges the direction of the course change or the right or left turn of the vehicle 100 based on the vehicle information in the step ST102.

In the step ST103, the display controller 34 makes the head-up display 49 as the display 35 display an image identical with the image reflected in the mirror surface part of a side mirror on the same side as the direction of a course change or a right or left turn of the vehicle 100 acquired from the vehicle information. In other words, based on the judgment in the step ST102, the display controller 34 makes the head-up display 49 as the display 35 display the display image of the same side as the direction of the course change or the right or left turn of the vehicle 100. In the vehicular display device 101 according to the first embodiment of the present invention, the display controller 34 makes the display 35 display an image identical with the image reflected in the mirror surface part 14 of the left side mirror, captured by the left side mirror camera 13 as the image capturing section 31, when the direction of the course change or the right or left turn of the vehicle 100 is the left direction with respect to the vehicle's traveling direction 6, for example, and makes the display 35 display an image identical with the image reflected in the mirror surface part 16 of the right side mirror, captured by the right side mirror camera 15 as the image capturing section 31, when the direction of the course change or the right or left turn of the vehicle 100 is the right direction with respect to the vehicle's traveling direction 6.

In step ST104, the display controller 34 acquires the vehicle information from the device-side communication section 30 similarly to the step ST101. The vehicle information acquired by the display controller 34 in the step ST104 may either be the same as the vehicle information acquired in the step ST101 or information not acquired in the step ST101 and is not particularly limited.

In step ST105, the display controller 34 judges whether the course change or the right or left turn of the vehicle 100 has finished or not based on the vehicle information acquired in the step ST104. The process advances to step ST106 when the display controller 34 judges that the course change or the right or left turn of the vehicle 100 has finished, or returns to the step ST104 when the display controller 34 judges that the course change or the right or left turn of the vehicle 100 has not finished yet.

In the judgment on whether the course change or the right or left turn of the vehicle 100 has finished or not, when the direction indicator information has started to include information indicating that a control circuit's electric current corresponding to the direction indicated by the direction indicator stopped flowing, application of voltage to the control circuit ended, or the input of a control signal to the control circuit ended, for example, the display controller 34 judges that the course change or the right or left turn of the vehicle 100 has finished based on the direction indicator information. Incidentally, the direction indicator information may either be information holding information on the control circuit (e.g., information indicating that the electric current stopped flowing) as it is or be information representing a judgment by the control circuit regarding the operating status of the direction indicator. In cases where the direction indicator information holds the information on the control circuit as it is, the display controller 34 judges the operating status of the direction indicator in addition.

Further, when the gyro sensor information has started to include information on an angle or angular speed in the left direction or right direction less than a threshold value, for example, the display controller 34 judges that the course change or the right or left turn of the vehicle 100 has finished based on the gyro sensor information. Furthermore, when the steering information has started to include information indicating a steering direction and a steering amount of the steering wheel less than a predetermined steering amount, for example, the display controller 34 judges that the course change or the right or left turn of the vehicle 100 has finished based on the steering information.

In the step ST106, based on the judgment in the step ST105, the display controller 34 ends the display of the display image of the direction of the course change or the right or left turn by the display 35. Then, the flowchart of the display controller 34 is ended.

Incidentally, in the above description of the vehicular display device 101 according to the first embodiment of the present invention, examples of cases where the left side mirror 1 is provided with the left side mirror camera 13 as the image capturing section 31 as shown in FIGS. 3 and 5 and where the right side mirror 2 is provided with the right side mirror camera 15 as the image capturing section 31 as shown in FIG. 5 have been explained. On the other hand, it is also possible as shown in FIG. 10 to provide the left side mirror surface image capturing camera 50a for capturing images of the mirror surface part 14 of the left side mirror or the right side mirror surface image capturing camera 50b for capturing images of the mirror surface part 16 of the right side mirror in the vehicle as the image capturing section 31.

In regard to the left side mirror surface image capturing camera 50a for capturing the mirror surface part 14 of the left side mirror or the right side mirror surface image capturing camera 50b for capturing the mirror surface part 16 of the right side mirror, the camera 45 having a wide field angle is used and images are captured so as to include the mirror surface part. In such cases, by processing the captured image with the image processor 33, an image of the mirror surface part 14 or 15 of a side mirror, reflected in the left side mirror 1 or the mirror surface part 16 of the right side mirror viewed from the driver, can be obtained. Then, the display controller 34 may make the display 35 display the image identical with the image reflected in the mirror surface part 14 or 15 of a side mirror, extracted from the captured image by the image processor 33, as the display image.

On the other hand, the left side mirror surface image capturing camera 50a for capturing the mirror surface part 14 of the left side mirror or the right side mirror surface image capturing camera 50b for capturing the mirror surface part 16 of the right side mirror may be provided to be capable of capturing an image identical with the image reflected in the left side mirror 1 or the mirror surface part 16 of the right side mirror viewed from the driver. In such cases, the processing by the image processor 33 becomes unnecessary.

Further, while the display controller 34 judging that the vehicle 100 makes a course change or a right or left turn automatically makes the display 35 display the display image in the above-described example, it is also possible to employ a configuration allowing the user to arbitrarily request the display of the display image via an input device (not shown).

Furthermore, since the image reflected in the mirror surface part 14 or 16 of a side mirror viewed from the driver of the vehicle 100 changes when the position of the viewpoint changes depending on the driver's sitting height or the like, the image capturing section 31 may be configured so that its direction is adjustable, or the image processor 33 may process the display image based on the captured image captured by the image capturing section 31 so as to be identical with the image viewed from the driver according to the position of the driver's viewpoint.

As described above, the vehicular display control device 102 in the first embodiment of the present invention includes the image acquisition section 32, the image processor 33, and the display controller 34. The image acquisition section 32 acquires the captured image captured by the image capturing section 31. The captured image includes an identical image identical with an image reflected in the side mirror of the vehicle viewed from the driver. The image processor 33 extracts the identical image from the captured image. The display controller 34 selects an image to be displayed as a display image by the head-up display 49 mounted on the vehicle in regard to the identical image extracted from the captured image by the image processor 33 and also controls timing of displaying the display image.

Further, the vehicular display control device 102 in the first embodiment of the present invention includes the image capturing section 31, the image acquisition section 32, and the display controller 34. The image capturing section 31 captures an image. The image acquisition section 32 acquires the captured image captured by the image capturing section 31. The captured image includes an identical image identical with an image reflected in the side mirror of the vehicle viewed from the driver. The display controller 34 make the head-up display 49 display the identical image as the display image.

Furthermore, the vehicular display device 101 in the first embodiment of the present invention includes the image acquisition section 32, the image processor 33, the display controller 34, and the display. The image acquisition section 32 acquires the captured image captured by the image capturing section 31. The captured image includes an identical image identical with an image reflected in the side mirror of the vehicle viewed from the driver. The image processor 33 extracts the identical image from the captured image. The display controller 34 selects an image to be displayed as a display image by the head-up display 49 mounted on the vehicle in regard to the identical image extracted from the captured image by the image processor 33 and also controls timing of displaying the display image. The display as the head-up display displays the display image.

With such configurations, at times of a right or left turn or a lane change of the vehicle, an image identical with the image viewed from the driver of the vehicle 100 is displayed by the head-up display 49, and thus the driver's confusion can be inhibited. Specifically, since the display image displayed by the head-up display 49 is an image identical with the image viewed from the driver, the display image does not significantly differ from the image viewed from the driver and the amount of information the driver receives does not increase more than needed. Accordingly, the driver's confusion caused by receiving many pieces of information can be inhibited.

Further, since an image identical with the image reflected in the mirror surface part 14 or 16 of the side mirror of the vehicle 100 viewed from the driver is displayed by the head-up display 49 as the display image on the windshield 22 in front of the driver at times of a right or left turn or a lane change of the vehicle 100, the movement of the driver's line of sight can be kept to the minimum. Accordingly, the driver can make the blind-spot safety check for a two-wheel vehicle 60 or the like at times of the right or left turn or the lane change of the vehicle 100 and the check for an obstacle such as a pedestrian in front of the vehicle 100 at the same time while keeping on watching the scene in front.

Further, the vehicular display control device 102 in the first embodiment of the present invention may include the image processor 33 configured to perform image processing for making the captured image be identical with the image viewed from the driver, and the display controller 34 may be configured to make the head-up display 49 display an image obtained by performing the image processing on the captured image as the display image.

With such a configuration, the degree of freedom in the installation of the image capturing section 31 increases, and thus the usability for the user improves. Further, even when the captured image differs from the image viewed from the driver, an image giving the same impression as the image viewed from the driver can be presented to the driver thanks to the image processing.

The vehicular display control device 102 in the first embodiment of the present invention may include the image processor 33 configured to extract the identical image from the captured image, and the display controller 34 may be configured to make the head-up display 49 display the identical image extracted from the captured image by the image processor 33 as the display image.

With such a configuration, by providing the camera 45 as the image capturing section 31 in the vehicle to capture an image of the mirror surface part 14 or 16 of the side mirror and having the image processor 33 process the captured image captured by the camera 45 provided in the vehicle, an image identical with the image viewed from the driver can be displayed by the head-up display 49 as the display image. Accordingly, the degree of freedom in the installation of the camera 45 increases.

The vehicular display control device 102 in the first embodiment of the present invention may include the device-side communication section 30 configured to acquire vehicle information including at least a piece of information selected from the steering information regarding the direction of steering of the steering wheel of the vehicle 100, the gyro sensor information including information on the angle or the angular speed of the vehicle 100, and the direction indicator information including information on a direction indicated by the direction indicator, and the display controller 34 may be configured to make the head-up display 49 display the display image of the same side as the direction of a course change or a right or left turn of the vehicle 100 acquired from the vehicle information.

The vehicular display device 101 according to the first embodiment of the present invention includes the device-side communication section 30 configured to acquire vehicle information including at least a piece of information selected from the steering information regarding the direction of steering of the steering wheel of the vehicle 100, the gyro sensor information including information on the angle or the angular speed of the vehicle 100, and the direction indicator information including information on a direction indicated by the direction indicator, and the display controller 34 includes the vehicular display control device 102 configured to make the head-up display 49 display the display image of the same side as the direction of a course change or a right or left turn of the vehicle 100 acquired from the vehicle information and a display 35b as the head-up display 49 configured to display the display image.

With such configurations, the display image of the same side as the direction of a course change or a right or left turn of the vehicle 100 acquired from the vehicle information can be displayed by the head-up display 49, and thus the movement of the driver's line of sight can be kept to the minimum. Accordingly, the driver can make the blind-spot safety check for a two-wheel vehicle or the like at times of the right or left turn or the course change of the vehicle 100 and the check for an obstacle such as a pedestrian in front of the vehicle 100 at the same time while keeping on watching the scene in front. Therefore, the vehicular display device 101 is capable of supporting the driver in the lane change or the right or left turn. Further, since the display controller 34 automatically judges whether or not to display the display image based on the vehicle information, the user does not have to give an instruction for the display. Accordingly, the convenience for the user is enhanced.

The vehicular display control device 302 according to the third embodiment of the present invention may include the device-side communication section 30 configured to acquire vehicle information including at least a piece of information selected from the steering information regarding the direction of steering of the steering wheel of the vehicle 100, the gyro sensor information including information on the angle or the angular speed of the vehicle, and the direction indicator information including information on a direction indicated by the direction indicator, and the display controller 34 may be configured to end the display of the display image when a course change or a right or left turn of the vehicle 100 is judged to have finished based on the vehicle information acquired by the device-side communication section 30 in cases where the display image is displayed by the head-up display 49.

With such a configuration, the display of the display image can be ended based on the vehicle information, and thus the display can be ended automatically at the time when the course change or the right or left turn of the vehicle 100 finishes and the display of the display image becomes unnecessary.

### Second Embodiment

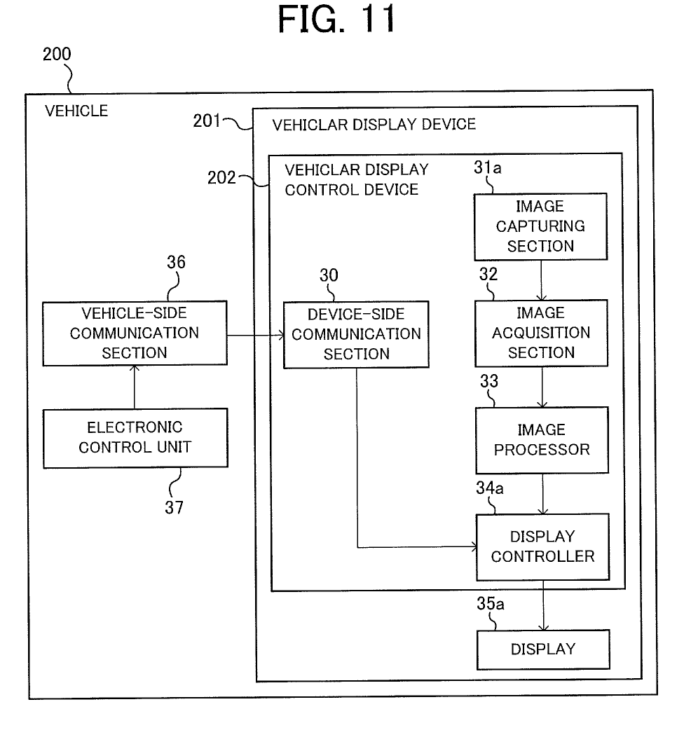

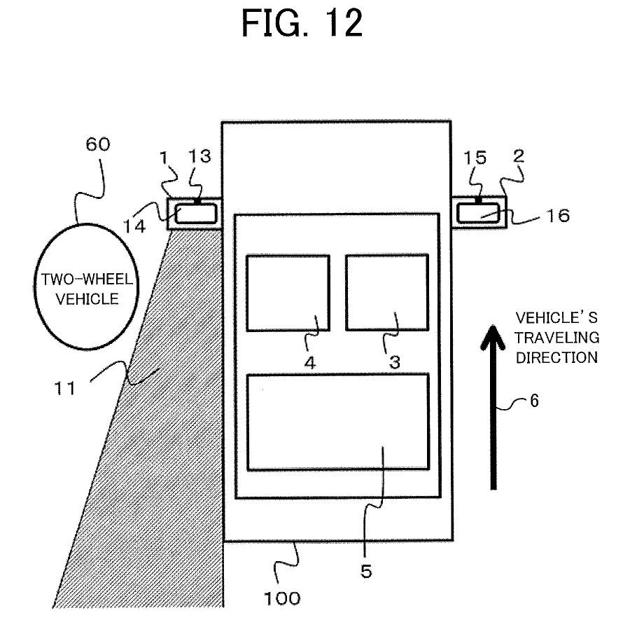

A vehicular display device 201 according to a second embodiment of the present invention will be described below with reference to FIGS. 11 to 17. In the vehicular display device 101 according to the first embodiment, the side mirror camera 1 or 2 is provided so that an image identical with the image reflected in the mirror surface part 14 or 16 of a side mirror viewed from the driver can be captured. In the second embodiment of the present invention, a description will be given of a modification further including an in-vehicle camera for capturing a captured image including the image obtained by the driver by facing to the left side or right side with respect to the vehicle's traveling direction 6. Specifically, in the second embodiment, in-vehicle cameras 61a-61e provided in the vehicle (FIGS. 14 to 16) are shown as an example of the camera 45 of the image capturing section 31. The following description will be given mainly of the difference from the first embodiment and description of identical or corresponding parts will be omitted properly.

FIG. 11 is a functional block diagram of the vehicular display device 201 according to the second embodiment of the present invention. The vehicular display device 201 according to the second embodiment of the present invention includes a display 35a for displaying the display image and a vehicular display control device 202. The vehicular display control device 202 includes an image capturing section 31a, the image acquisition section 32, the image processor 33, a display controller 34a and the device-side communication section 30. The vehicle 200 shown in FIG. 11 includes the vehicle-side communication section 36 and the electronic control unit 37. The vehicular display device 201 according to the second embodiment of the present invention differs from the vehicular display device 201 according to the first embodiment of the present invention in the installation position of the image capturing section 31a, the control method of the display controller 34a, and the display by the display 35a.

FIG. 12 is a diagram showing the left side mirror visual field range 11 of the left side mirror 1. The left side mirror visual field range 11 shown in FIG. 12 is the range of the image reflected in the mirror surface part 14 of the left side mirror viewed from the driver. The two-wheel vehicle 60 outside of the left side mirror visual field range 11 is an obstacle such as a motorcycle and is situated in the blind spot of the left side mirror 1. Therefore, even when the driver checks the left side mirror 1, the two-wheel vehicle 60 is not in the image on the mirror surface part 14 of the left side mirror viewed from the driver.

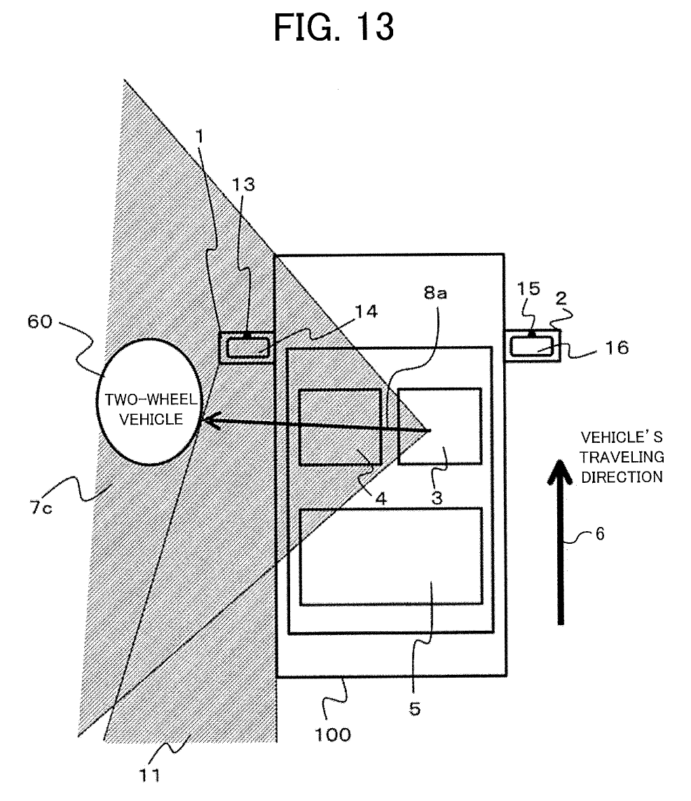

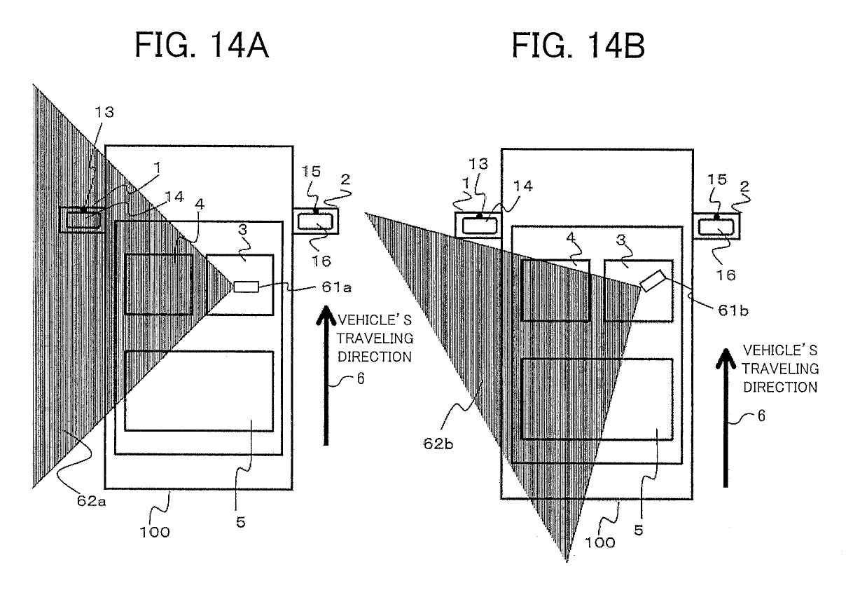

FIG. 13 is a diagram showing the visual field 7c of the driver obtained when the driver faces to the left side with respect to the vehicle's traveling direction 6. The driver's visual field 7c shown in FIG. 13 is the left side mirror visual field range 11 shown in FIG. 12 plus a visual field range the driver can directly view when the driver points the fixation point direction 8a towards the two-wheel vehicle 60. When the driver points the fixation point direction 8a towards the two-wheel vehicle 60, the two-wheel vehicle 60 enters the range of the driver's visual field 7. Thus, the driver can recognize the two-wheel vehicle 60, which was unrecognizable with the left side mirror 1 alone, by pointing the fixation point direction 8a towards the two-wheel vehicle 60. A similar thing goes for cases of using the right side mirror 2.

FIG. 14 shows in-vehicle camera image capturing ranges 62a and 62b of the vehicular display device 201 according to the second embodiment of the present invention. In FIG. 14A, the in-vehicle camera 61a is capturing an image in the left direction with respect to the vehicle's traveling direction 6. In FIG. 14B, the in-vehicle camera 61b is capturing an image in a left rear direction with respect to the vehicle's traveling direction 6. FIG. 14A shows the in-vehicle camera image capturing range 62a for capturing an image with the in-vehicle camera 61a so that the captured image includes the image viewed from the driver in the case where the driver faces to the left side and points the fixation point direction towards the left door window of the passenger seat 4. FIG. 14B shows the in-vehicle camera image capturing range 62b for capturing an image with the in-vehicle camera 61b so that the captured image includes the image viewed from the driver in the case where the driver faces to the left side and points the fixation point direction towards the left door window of the rear seat 5.

A similar thing goes for cases where the in-vehicle camera is provided to capture an image in the right direction or a right rear direction with respect to the vehicle's traveling direction 6. Specifically, in cases where the in-vehicle camera is provided to capture an image in the right direction with respect to the vehicle's traveling direction 6, the image is captured so as to include the image viewed from the driver in the case where the driver faces to the right side and points the fixation point direction towards the right door window of the driver seat 3. In cases where the in-vehicle camera is provided to capture an image in a right rear direction with respect to the vehicle's traveling direction 6, the image is captured so as to include the image viewed from the driver in the case where the driver faces to the right side and points the fixation point direction towards the right door window of the rear seat 5.

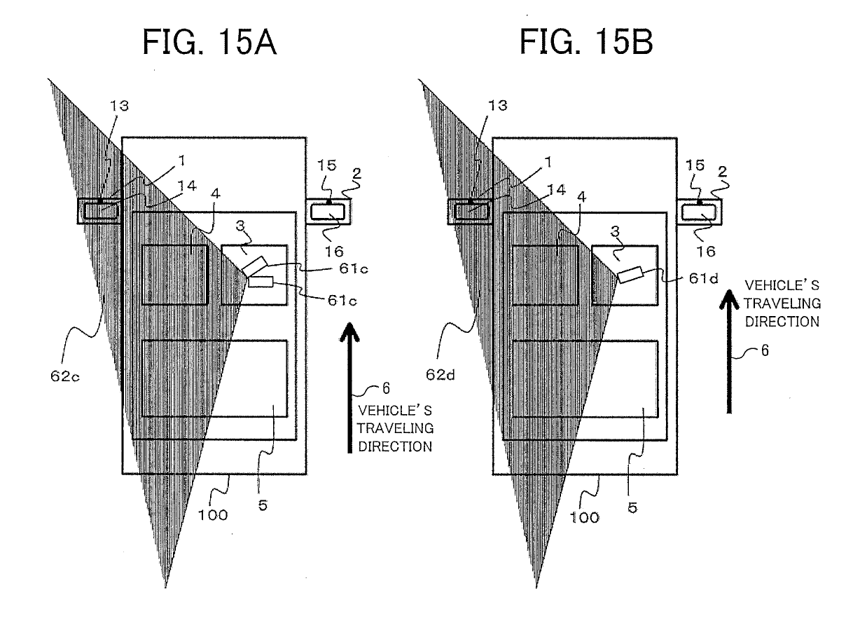

FIG. 15 shows in-vehicle camera image capturing ranges 62c and 62d of the vehicular display device 201 according to the second embodiment of the present invention. In FIG. 15A, the arrangement of two in-vehicle cameras 61c is made to capture both the in-vehicle camera image capturing range 62a in FIG. 14A and the in-vehicle camera image capturing range 62b in FIG. 14B at the same time. In FIG. 15B, a single in-vehicle camera 61d has a wide field angle and is capable of capturing both the in-vehicle camera image capturing range 62a in FIG. 14A and the in-vehicle camera image capturing range 62b in FIG. 14B at the same time. Thus, the pair of in-vehicle cameras 61c or the in-vehicle camera 61d is capable of simultaneously capturing a captured image including the image viewed from the driver in the case where the driver faces to the left side and points the fixation point direction towards the left door window of the passenger seat 4 and a captured image including the image viewed from the driver in the case where the driver faces to the left side and points the fixation point direction towards the left door window of the rear seat 5.

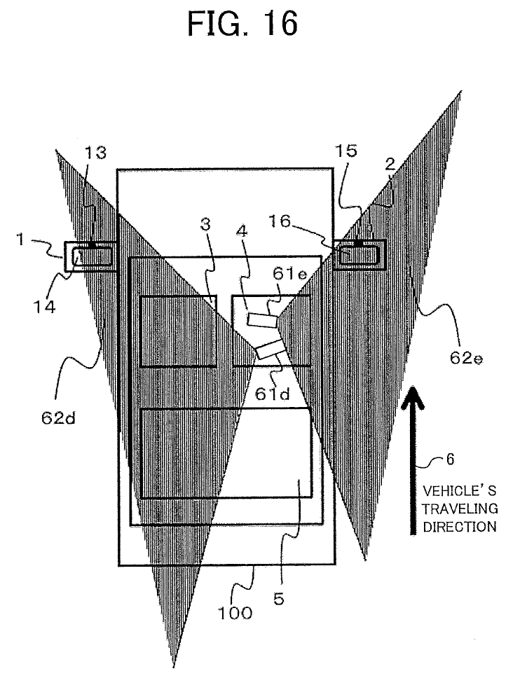

FIG. 16 shows in-vehicle camera image capturing ranges 62d and 62e of the vehicular display device 201 according to the second embodiment of the present invention. This is an example of further arranging an in-vehicle camera 61e for capturing a captured image including an image obtained by the driver by facing to the right side with respect to the vehicle's traveling direction 6 in addition to the in-vehicle camera 61d shown in FIG. 15B. With this arrangement, even when a two-wheel vehicle 60 exists in the blind spot of the side mirror 1 or 2, either on the left side or right side with respect to the vehicle's traveling direction 6, the two-wheel vehicle 60 in the blind spot can be captured with the in-vehicle camera 61d or 61e.

Incidentally, the flowchart of the display controller 34a according to the second embodiment of the present invention is the same as or corresponds to the flowchart of the display controller 34 according to the first embodiment shown in FIG. 9. Thus, similarly to the step 103 in FIG. 9, the display controller 34a makes the head-up display 49 as the display 35a display the display image of the same side as the direction of the course change or the right or left turn of the vehicle 200.

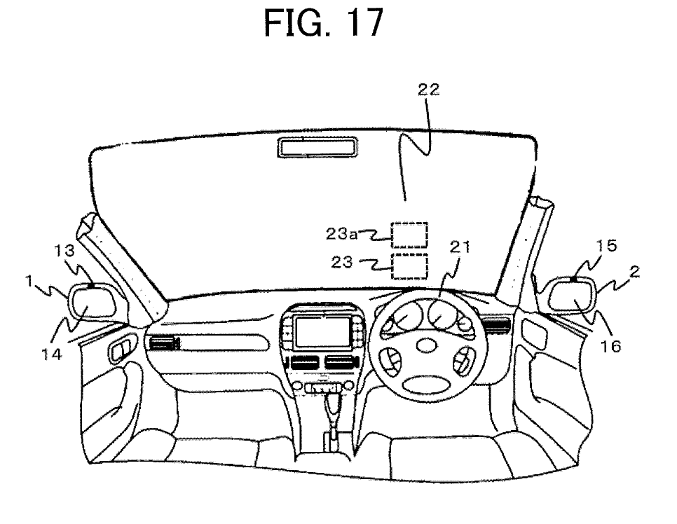

FIG. 17 shows the interior of the vehicle 200 according to the second embodiment of the present invention. In the first embodiment, a display image based on a captured image captured by the left side mirror camera 13 or the right side mirror camera 15 is displayed on the display screen 23 as shown in FIG. 5. In FIG. 17, the vehicular display device 201 displays a display image based on a captured image captured by the left side mirror camera 13 on the display screen 23 and displays a display image based on a captured image obtained by capturing the left side with respect to the vehicle's traveling direction 6 with one of the in-vehicle cameras 61a-61d on a display screen 23a, for example. While a case where the direction of the course change or the right or left turn of the vehicle 200 is the left direction has been explained here, a display image based on a captured image obtained by capturing the right side with respect to the vehicle's traveling direction 6 is displayed on the display screen 23a in cases where the direction of the course change or the right or left turn of the vehicle is the right direction.

Incidentally, the vehicular display device 201 may also be configured to display the display image based on the captured image captured by the left side mirror camera 13 on the display screen 23a and display the image obtained by capturing the left side with respect to the vehicle's traveling direction 6 with one of the in-vehicle cameras 61a-61d on the display screen 23.

Further, while the display screens 23 and 23a are provided one above the other in FIG. 17, it is also possible to arrange the display screens 23 and 23a side by side. Also when the display screens 23 and 23a are provided side by side, the display positions of the display image based on the captured image captured by the side mirror camera 13 or 15 and the display image based on the captured image captured by the in-vehicle cameras 61a-61e may be interchanged.

While the vehicular display control device 201 according to the second embodiment of the present invention is configured to further arrange the in-vehicle cameras 61a-61e in addition to the side mirror cameras 13 and 14, it is also possible to arrange the in-vehicle cameras 61a-61e instead of the side mirror cameras 13 and 15. Further, the installation positions of the in-vehicle cameras 61a-61e shown in FIGS. 14 to 16 are just an example and are not limited to this example as long as the installation positions allows for the capturing of captured images each including an image obtained by the driver by facing to the left side or right side.

As described above, the vehicular display control device 202 according to the second embodiment of the present invention includes the image acquisition section configured to acquire a captured image captured by the image capturing section provided in the vehicle and including an image obtained by the driver by facing to the left side or right side with respect to the vehicle's traveling direction 6 and the display controller configured to make the head-up display display the captured image as the display image.

With such a configuration, even when an obstacle such as a two-wheel vehicle 60 exists in the blind spot of the left side mirror 1 or the right side mirror 2, the obstacle such as the two-wheel vehicle 60 can be checked and recognized with ease thanks to the display image displayed by the head-up display 49. Thus, the driver does not need to face to the left side or the right side with respect to the vehicle's traveling direction. Accordingly, the driver can easily check and recognize an obstacle on the left side or the right side with respect to the vehicle's traveling direction while facing forward and driving the vehicle, and the movement of the driver's line of sight can be kept to the minimum.

Further, the vehicular display control device 202 in the first embodiment of the present invention may include the image processor 33 configured to perform image processing for making the captured image be identical with the image obtained by the driver by facing to the left side or right side with respect to the vehicle's traveling direction, and the display controller 34b may be configured to make the head-up display 49 display an image obtained by performing the image processing on the captured image as the display image.

With such a configuration, the degree of freedom in the installation of the image capturing section 31 increases, and thus the usability for the user improves. Further, even when the captured image differs from the image viewed from the driver, an image giving the same impression as the image viewed from the driver can be presented to the driver thanks to the image processing.

The vehicular display device 201 according to the second embodiment of the present invention may include the vehicular display control device 202 described above and the display 35a as the head-up display 49 for displaying the display image.

With such a configurations, at times of a right or left turn or a lane change of the vehicle, an image identical with the image viewed from the driver of the vehicle 200 is displayed by the head-up display 49, and thus the driver's confusion can be inhibited. Specifically, since the display image displayed by the head-up display 49 is an image identical with the image viewed from the driver, the display image does not significantly differ from the image viewed from the driver and the amount of information the driver receives does not increase more than needed. Thus, the driver's confusion caused by receiving many pieces of information can be inhibited.

### Third Embodiment

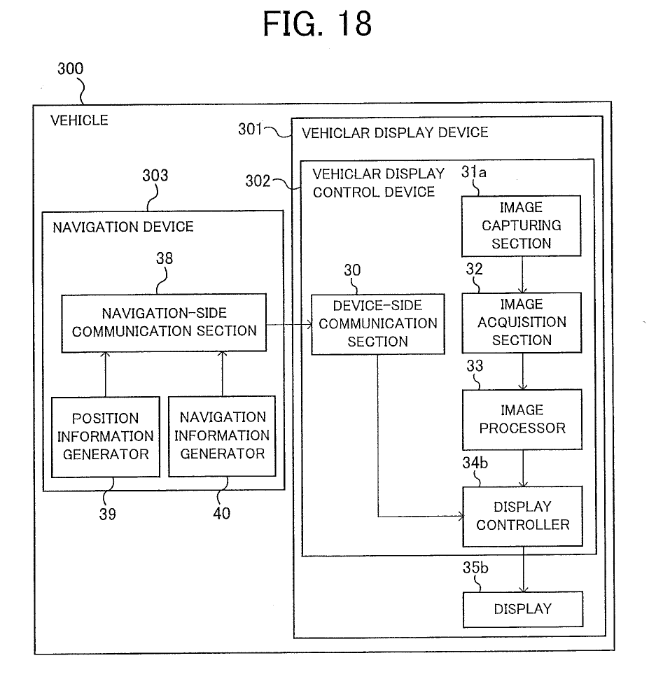

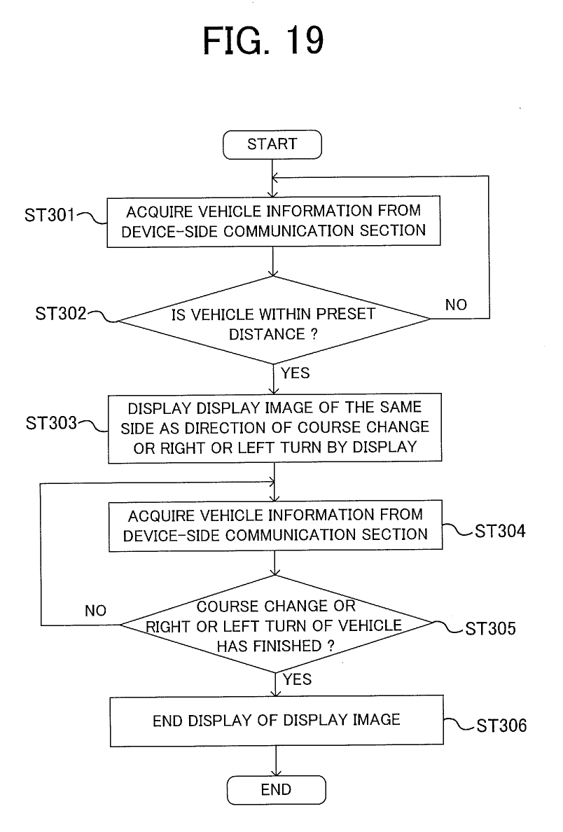

A vehicular display device 301 according to a third embodiment of the present invention will be described below with reference to FIGS. 18 and 19. In the vehicular display device 201 according to the second embodiment, the vehicular display device 201 acquires the vehicle information from the electronic control unit 37 via the vehicle-side communication section 36 of the vehicle 200. In the third embodiment of the present invention, a description will be given of a modification in which the vehicular display device 301 acquires information on the current position of the vehicle 300 and information on a navigation point where a course change or a right or left turn has been scheduled to be made from a position information generator 39 and a navigation information generator 40 as the vehicle information via a navigation-side communication section 38 of a navigation device 303. The following description will be given mainly of the difference from the second embodiment and description of identical or corresponding parts will be omitted properly.

FIG. 18 is a functional block diagram of the vehicular display device 301 according to the third embodiment of the present invention. The vehicular display device 301 according to the third embodiment of the present invention includes a display 35b for displaying the display image and a vehicular display control device 302. The vehicular display control device 302 includes the image capturing section 31a, the image acquisition section 32, the image processor 33, a display controller 34b and the device-side communication section 30. The navigation device 303 shown in FIG. 18 includes the navigation-side communication section 38, the position information generator 39 and the navigation information generator 40.

The vehicular display device 301 according to the third embodiment of the present invention differs from the vehicular display device 201 according to the second embodiment of the present invention in the control method of the display controller 34b. Further, while the device-side communication section 30 in the second embodiment acquires the vehicle information from the electronic control unit 37 via the vehicle-side communication section 36, the device-side communication section 30 in the third embodiment differs in acquiring vehicle information from the position information generator 39 and the navigation information generator 40 via the navigation-side communication section 38.

Next, the operation of the vehicular display device 301 according to the third embodiment of the present invention will be described below. FIG. 19 is a flowchart of the display controller 34b according to the third embodiment of the present invention. The flowchart of FIG. 19 may either be executed periodically or started in response to the reception of a start signal from the device-side communication section 30 by the display controller 34b. In FIG. 19, the image capturing section 31a is the left side mirror camera 13, the right side mirror camera 15, or the in-vehicle cameras 61a-61e, and the display 35b is the head-up display 49.

In step ST301, the display controller 34b acquires the vehicle information from the device-side communication section 30. In the vehicular display device 301 according to the third embodiment of the present invention, the acquired vehicle information is the information on the current position of the vehicle 300 and the information on the navigation point where a course change or a right or left turn has been scheduled to be made. The information on the current position of the vehicle 300 is generated by the position information generator 39 based on a GPS signal or the like. The information on the navigation point is information on each point where the vehicle 300 has been scheduled to make the course change or the right or left turn in a route to a destination previously set on the navigation device 303 by the user, for example. The information on the navigation point is generated by the navigation information generator 40.

In step ST302, the display controller 34b judges whether or not the navigation point and the current position of the vehicle 300 are within a predetermined distance based on the vehicle information acquired in the step ST301 including the information on the current position of the vehicle 300 and the information on the navigation point where a course change or a right or left turn has been scheduled to be made. The process advances to step ST303 when the display controller 34b judges that the navigation point and the current position of the vehicle 300 are within the predetermined distance, or returns to the step ST301 when the display controller 34b judges that the navigation point and the current position of the vehicle 300 are not within the predetermined distance.

In the step ST303, in the case where the navigation point and the current position are within the predetermined distance based on the vehicle information, the display controller 34b makes the display 35 as the head-up display 49 display the display image. Similarly to the second embodiment, the display image that is displayed is the display image of the same direction as the course change or the right or left turn of the vehicle 300.

For example, when the vehicle 300 makes the course change or turn to the left side with respect to the traveling direction, the display controller 34b causes a display image based on a captured image captured by the left side mirror camera 13 and a display image based on a captured image captured by one of the in-vehicle cameras 61a-61d provided in the vehicle to be displayed on the display screens 23 and 23a. When the vehicle 300 makes the course change or turn to the right side with respect to the traveling direction, the display controller 34b causes a display image based on a captured image captured by the right side mirror camera 15 and a display image based on a captured image captured by the in-vehicle camera 61e provided in the vehicle to be displayed on the display screens 23 and 23a.

In step ST304, the display controller 34b acquires the vehicle information from the device-side communication section 30 similarly to the step ST301. In the step ST304, the display controller 34b acquires at least the information on the current position of the vehicle 300, included in the vehicle information, and updates the current position of the vehicle 300.

In step ST305, the display controller 34b judges whether the course change or the right or left turn of the vehicle 300 has finished or not based on the vehicle information acquired in the step ST304. The process advances to step ST306 when the display controller 34b judges that the course change or the right or left turn of the vehicle 300 has finished, or returns to the step ST304 when the display controller 34b judges that the course change or the right or left turn of the vehicle 300 has not finished yet. In the judgment on whether the course change or the right or left turn of the vehicle 300 has finished or not, when the display image is displayed by the head-up display as the display 35 and the distance between the navigation point and the current position has exceeded a predetermined distance based on the vehicle information acquired from the device-side communication section 30, the display controller 34b judges that the course change or the right or left turn of the vehicle has finished.

Incidentally, the display controller 34b in the step ST302 or the step ST305 acquires the vehicle information, including the information on the current position and the information on the navigation point where the course change or the right or left turn has been scheduled to be made, via the device-side communication section 30. However, the vehicle information that is acquired is not limited to this example; the display controller 34b in the step ST302 or the step ST305 may additionally acquire via the vehicle-side communication section 36 the vehicle information including the steering information regarding the direction of steering of the steering wheel of the vehicle 300, the gyro sensor information including information on the angle or the angular speed of the vehicle 300, and the direction indicator information including information on a direction indicated by the direction indicator acquired from the electronic control unit 37 of the vehicle 300.

In the step ST306, the display controller 34b ends the display of the display image and the flowchart is ended.

As described above, the vehicular display control device 302 according to the third embodiment of the present invention includes the device-side communication section 30 configured to acquire the vehicle information including the information on the current position of the vehicle 300 and the information on the navigation point where a course change or a right or left turn has been scheduled to be made, and the display controller 34b makes the head-up display 49 display the display image when the navigation point and the current position are within a predetermined distance based on the vehicle information.

The vehicular display device 301 according to the third embodiment of the present invention includes the device-side communication section 30 configured to acquire the vehicle information including the information on the current position of the vehicle 300 and the information on the navigation point where a course change or a right or left turn has been scheduled to be made, and the display controller 34b includes the vehicular display control device 302 configured to make the head-up display 49 display the display image when the navigation point and the current position are within a predetermined distance based on the vehicle information and the display 35b as the head-up display 49 configured to display the display image.

With such configurations, when the navigation point and the current position have come within the predetermined distance, the display image is automatically displayed by the head-up display 49, and thus the driver can easily check an obstacle on the left side or the right side with respect to the vehicle's traveling direction while facing forward and driving the vehicle, and the movement of the driver's line of sight can be kept to the minimum.

The vehicular display control device according to the third embodiment of the present invention may include the device-side communication section 30 configured to acquire the vehicle information including the information on the current position of the vehicle 300 and the information on the navigation point where a course change or a right or left turn has been scheduled to be made, and the display controller 34b may end the display of the display image when the course change or the right or left turn of the vehicle 300 is judged to have finished in cases where the display image is displayed by the head-up display 49 and the distance between the navigation point and the current position exceeds a predetermined distance based on the vehicle information acquired by the device-side communication section 30.

The vehicular display device 301 according to the third embodiment of the present invention includes the device-side communication section 30 configured to acquire the vehicle information including the information on the current position of the vehicle 300 and the information on the navigation point where a course change or a right or left turn has been scheduled to be made, and the display controller 34b includes the vehicular display control device 302 configured to end the display of the display image when the course change or the right or left turn of the vehicle 300 is judged to have finished in cases where the display image is displayed by the head-up display 49 and the distance between the navigation point and the current position exceeds a predetermined distance based on the vehicle information acquired by the device-side communication section 30 and the display 35b as the head-up display 49 configured to display the display image.

With such configurations, when the distance between the navigation point and the current position exceeds the predetermined distance in cases where the display image is displayed by the head-up display 49, the display of the display image is automatically ended, and thus the driver does not need to end the display for himself/herself.

### Fourth Embodiment

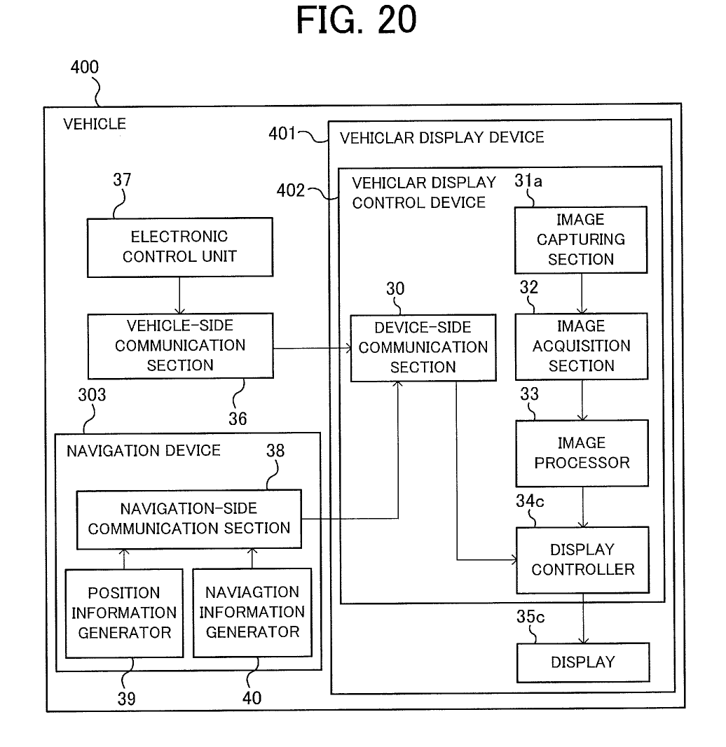

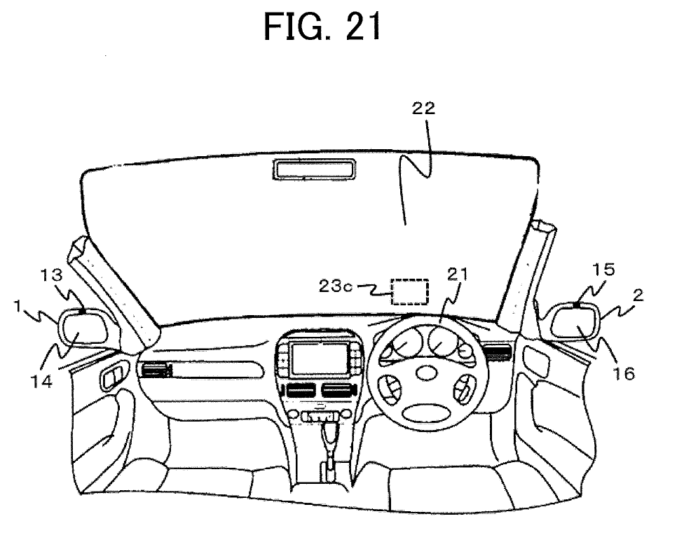

A vehicular display device 401 according to a fourth embodiment of the present invention will be described below with reference to FIGS. 20 to 22. In the fourth embodiment of the present invention, a description will be given of a modification of the display method in regard to the display image based on the captured image captured by the left side mirror camera 13 or the right side mirror camera 15 and the display image based on the captured image captured by the in-vehicle cameras 61a-61e. The following description will be given mainly of the difference from the third embodiment and description of identical or corresponding parts will be omitted.

FIG. 20 is a functional block diagram of the vehicular display device 401 according to the fourth embodiment of the present invention. The vehicular display device 401 according to the fourth embodiment of the present invention includes a display 35c for displaying the display image and a vehicular display control device 402. The vehicular display control device 402 includes the image capturing section 31a, the image acquisition section 32, the image processor 33, a display controller 34c and the device-side communication section 30. The vehicle 400 shown in FIG. 20 includes the vehicle-side communication section 36 and the electronic control unit 37. The navigation device 303 includes the navigation-side communication section 38, the position information generator 39 and the navigation information generator 40. The vehicular display device 401 according to the fourth embodiment of the present invention differs from the vehicular display device 301 according to the third embodiment of the present invention in the control method of the display controller 34c and the display method of the display 35c in the vehicular display device 401. The electronic control unit 37 and the vehicle-side communication section 36 correspond to those in the first embodiment, and thus repeated description thereof is omitted here.

FIG. 21 shows the interior of the vehicle 400 according to the fourth embodiment of the present invention. In the third embodiment, as shown in FIG. 17, the vehicular display device 201 displays the display image based on the captured image captured by the side mirror camera 13 or 15 and the display image based on the captured image captured by one of the in-vehicle cameras 61a-61e provided in the vehicle on the display screens 23 and 23a. In the fourth embodiment of the present invention, the display image based on the captured image captured by the side mirror camera 13 or 15 and the display image based on the captured image captured by one of the in-vehicle cameras 61a-61e provided in the vehicle are successively switched and displayed on one display screen 23c.

Incidentally, the display image based on the captured image captured by the side mirror camera 13 or 15 is an image identical with an image viewed from the driver. The display image based on the captured image captured by one of the in-vehicle cameras 61a-61e is an image including an image identical with an image viewed from the driver or an image identical with the image viewed from the driver.

For example, a display image based on a captured image captured by the left side mirror camera 13 is displayed on the display screen 23c and thereafter a display image based on a captured image captured by one of the in-vehicle cameras 61a-61d provided in the vehicle, as a captured image including an image obtained by the driver by facing to the left side with respect to the vehicle's traveling direction 6, is displayed on the display screen 23c. Alternatively, a display image based on a captured image captured by the right side mirror camera 15 is displayed on the display screen 23c and thereafter a display image based on a captured image captured by the in-vehicle camera 61e, as a captured image including an image obtained by the driver by facing to the right side with respect to the vehicle's traveling direction 6, is displayed on the display screen 23c.

While an example of displaying a display image based on a captured image captured by the side mirror camera 13 on the display screen 23c and thereafter displaying a display image based on a captured image captured by one of the in-vehicle cameras 61a-61e provided in the vehicle on the display screen 23c is described here, the displaying order is not limited to this example. It is also possible to display a display image based on a captured image captured by one of the in-vehicle cameras 61a-61e provided in the vehicle on the display screen 23c and thereafter display a display image based on a captured image captured by the side mirror camera 13 on the display screen 23c. Further, the arrangement of the in-vehicle cameras 61a-61e in the vehicle is just an example and is not limited to this example as long as each of the in-vehicle cameras 61a-61e is capable of capturing a captured image including an image obtained by the driver by facing to the left side or right side with respect to the vehicle's traveling direction 6.

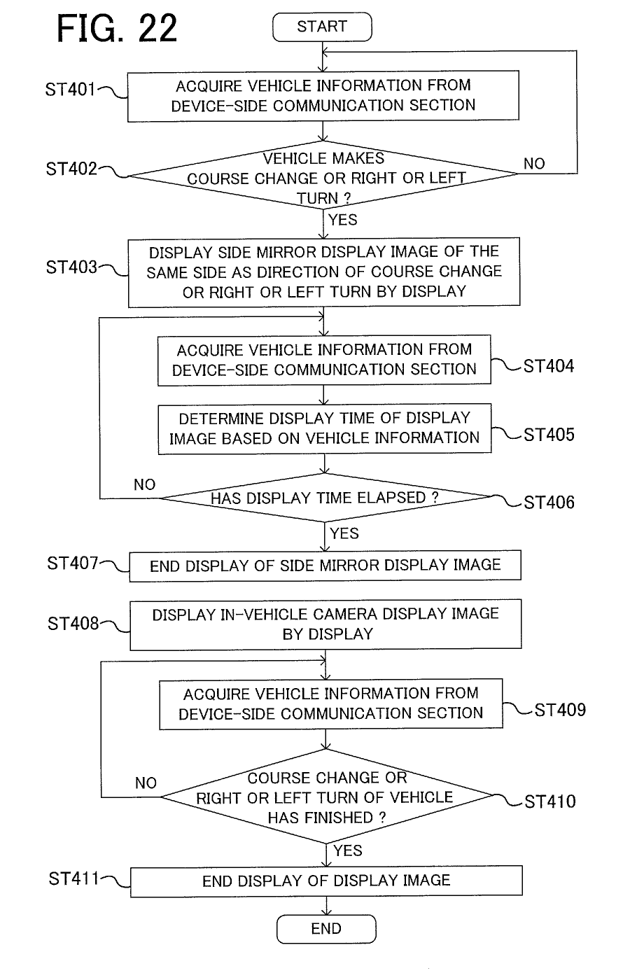

Next, the operation of the vehicular display device 401 according to the fourth embodiment of the present invention will be described below. FIG. 22 is a flowchart of the display controller 34c according to the fourth embodiment of the present invention. In the flowchart of FIG. 22, as compared with the flowchart of FIG. 9, steps ST402, ST410 and ST411 correspond to the steps ST102, ST105 and ST106, respectively. The following description will be given of step ST401 and steps ST403 to ST409. In FIG. 22, the image capturing section 31a is the left side mirror camera 13, the right side mirror camera 15, or the in-vehicle cameras 61a-61e, and the display 35c is the head-up display 49.

In each of the steps ST401, ST404 and ST409, the display controller 34 acquires the vehicle information from the device-side communication section 30. The acquired vehicle information includes at least a piece of information selected from the steering information regarding the direction of steering of the steering wheel of the vehicle 400, the gyro sensor information including information on the angle or the angular speed of the vehicle 400, and the direction indicator information including information on a direction indicated by the direction indicator. It is also possible to further acquire speed information and acceleration information on the vehicle 400 or acquire the information on the current position of the vehicle 400, the information on the navigation point, etc. from the navigation device 303 in addition to the above-described vehicle information. The vehicle information acquired by the display controller 34 in each of the steps ST401, ST404 and ST409 may either be the same vehicle information or different vehicle information and is not particularly limited.

In the step ST403, the display controller 34c makes the display 35c as the head-up display 49 display a display image based on a captured image captured by the side mirror camera 13 or 15 in the direction of the course change or the right or left turn based on the judgment in the step ST402. The display controller 34c makes the display 35c display a display image based on a captured image captured by the left side mirror camera 13 when the direction of the course change or the right or left turn is the left direction with respect to the vehicle's traveling direction 6, for example, and makes the display 35c display a display image based on a captured image captured by the right side mirror camera 15 when the direction of the course change or the right or left turn is the right direction with respect to the vehicle's traveling direction 6.

In step ST405, the display controller 34c adjusts the display time of the display image based on the captured image captured by the left side mirror camera 13 or the display image based on the captured image captured by the right side mirror camera 15 displayed by the display 35c based on the vehicle information acquired in the step ST404. The display controller 34c determines the display image's display time the driver generally needs for the course change or the right or left turn in the initial stage of making the course change or the right or left turn based on the information on the current position of the vehicle 400, the information on the navigation point and the speed information on the vehicle 400, for example, included in the vehicle information acquired in the step ST404.

In step ST406, the display controller 34c judges whether the display time determined in the step ST405 has elapsed or not. The process advances to step ST407 when the display controller 34c judges that the display time has elapsed, or returns to the step ST404 when the display controller 34c judges that the display time has not elapsed yet. In the case of returning to the step ST404, the display controller 34c acquires the vehicle information on the vehicle 400 via the device-side communication section 30 again in the step ST404. In the step ST405, the display controller 34c updates the display time of the display image based on the captured image captured by the left side mirror camera 13 or the display image based on the captured image captured by the right side mirror camera 15 based on the acquired vehicle information.

The process advances to the step ST407 when the display controller 34c judges in the step ST406 that the display time has elapsed. In the step ST407, the display controller 34c ends the display of the display image based on the captured image captured by the left side mirror camera 13 or the display image based on the captured image captured by the right side mirror camera 15 since the step ST403.

In step ST408, the display controller 34c makes the display 35c display a display image based on a captured image captured by one of the in-vehicle cameras 61a-61e provided in the vehicle that is in the same direction with respect to the vehicle's traveling direction 6 as the display image based on the captured image captured by the left side mirror camera 13 or the display image based on the captured image captured by the right side mirror camera 15 whose display was ended in the step ST407.

In the step ST410, it is of course possible, in addition to the contents of the step ST105 in FIG. 9, to use the information on the current position of the vehicle 400 and the information on the navigation point for the judgment on whether the course change or the right or left turn of the vehicle has finished or not. In the determination of the display time of the display image in the step ST405, it is also possible to allow the user to arbitrarily set the display time.

As described above, in the vehicular display control device 402 according to the fourth embodiment of the present invention, the display controller 34b makes the head-up display 49 display an image identical with the image reflected in the mirror surface part 14 or 16 of a side mirror as the display image and thereafter switches the display and makes the head-up display 49 display a captured image including an image obtained by the driver by facing to the left side or right side with respect to the vehicle's traveling direction 6 as the display image, or makes the head-up display 49 display a captured image including an image obtained by the driver by facing to the left side or right side with respect to the vehicle's traveling direction 6 as the display image and thereafter switches the display and makes the head-up display 49 display an image identical with the image reflected in the mirror surface part 14 or 16 of a side mirror as the display image.

The vehicular display device 401 according to the fourth embodiment of the present invention may include the vehicular display control device 402 described above and the display 35c as the head-up display 49 for displaying the display image.

With such configurations, the display controller 34c displays a display image based on a captured image captured by the side mirror camera 13 or 15 on the display screen 23c and thereafter switches the display and displays a display image based on a captured image captured by one of the in-vehicle cameras 61a-61e on the display screen 23c. Therefore, the driver can check the rear view from the vehicle 400 with the display image regarding the side mirror cameras 13 and 15 and thereafter make the blind-spot safety check for a two-wheel vehicle 60 or the like with the display image regarding the in-vehicle cameras 61a-61e. Since a plurality of display images are switched and displayed on one display screen 23c, it is unnecessary to provide a plurality of display screens 23c or to provide a display screen 23c in a large area. Accordingly, an effect is achieved in that costs for providing a plurality of display screens 23c or providing a display screen 23c in a large area can be saved.

Incidentally, it is possible in the present invention to freely combine some of the embodiments or properly modify or leave out part of each embodiment within the scope of the present invention.

### DESCRIPTION OF REFERENCE CHARACTERS

30: device-side communication section, 31, 31a: image capturing section, 32: image acquisition section, 33: image processor, 34, 34a, 34b, 34c: display controller, 35, 35a, 35b, 35c: display, 102, 202, 302, 402: vehicular display control device, 101, 201, 301, 401: vehicular display device

1-9. (canceled)

10. A vehicular display control device comprising:
an image acquisition section configured to acquire a first captured image obtained by capturing a back or a side of a vehicle and a second captured image including an image obtained by a driver of the vehicle by facing to a left side or a right side with respect to a vehicle's traveling direction;
a display controller configured to make a head-up display mounted on the vehicle display both of a first display image based on the first captured image and a second display image based on the second captured image on different display screens respectively.

11. The vehicular display control device according to claim 10, wherein the first captured image includes a view range of a side mirror.

12. The vehicular display control device according to claim 10, wherein the second captured image is captured by a second image capturing section provided in the vehicle.

13. A vehicular display control device comprising:
an image acquisition section configured to acquire a first captured image obtained by capturing a back or a side of a vehicle and a second captured image including an image obtained by a driver of the vehicle by facing to a left side or a right side with respect to a vehicle's traveling direction; and
a display controller configured to make a head-up display mounted on the vehicle display one of a first display image based on the first captured image and a second display image based on the second captured image, to make the head-up display end the display of the display image after predetermined time has passed, and to make the head-up display display a display image different from the display image of the first display image and the second display image which has been displayed by the head-up display.

14. The vehicular display control device according to claim 13, wherein the first captured image includes a view range of a side mirror.

15. The vehicular display control device according to claim 13, wherein the second captured image is captured by a second image capturing section provided in the vehicle.

16. The vehicular display control device according to claim 13, the predetermined display time is set based on an instruction from a user.

17. The vehicular display control device according to claim 10, further comprising a device-side communication section configured to acquire vehicle information including at least a piece of information selected from steering information regarding a direction of steering of a steering wheel of the vehicle, gyro sensor information including information on an angle or angular speed of the vehicle, and direction indicator information including information on a direction indicated by a direction indicator,
wherein the display controller makes the head-up display display the display image of the same side as a direction of a course change or a right or left turn of the vehicle acquired from the vehicle information.

18. The vehicular display control device according to claim 10, further comprising a device-side communication section configured to acquire vehicle information including information on a current position of the vehicle and information on a navigation point where a course change or a right or left turn has been scheduled to be made,
wherein the display controller makes the head-up display display the display image when the navigation point and the current position are within a predetermined distance based on the vehicle information.

19. The vehicular display control device according to claim 10, further comprising a device-side communication section configured to acquire vehicle information including at least a piece of information selected from steering information regarding a direction of steering of a steering wheel of the vehicle, gyro sensor information including information on an angle or angular speed of the vehicle, and direction indicator information including information on a direction indicated by a direction indicator,
wherein the display controller ends the display of the display image when a course change or a right or left turn of the vehicle is judged to have finished based on the vehicle information acquired by the device-side communication section in cases where the first display image and the second display image are displayed by the head-up display.

20. The vehicular display control device according to claim 13, further comprising a device-side communication section configured to acquire vehicle information including at least a piece of information selected from steering information regarding a direction of steering of a steering wheel of the vehicle, gyro sensor information including information on an angle or angular speed of the vehicle, and direction indicator information including information on a direction indicated by a direction indicator,
wherein the display controller ends the display of the display image different from the display image which has been displayed by the head-up display when a course change or a right or left turn of the vehicle is judged to have finished based on the vehicle information acquired by the device-side communication section in cases where the display image different from the display image which has been displayed by the head-up display is displayed by the head-up display.

21. The vehicular display control device according to claim 10, further comprising a device-side communication section configured to acquire vehicle information including information on a current position of the vehicle and information on a navigation point where a course change or a right or left turn has been scheduled to be made,
wherein the display controller ends the display of the display image when a course change or a right or left turn of the vehicle is judged to have finished in cases where the display image is displayed by the head-up display and the navigation point and the current position exceed a predetermined distance based on the vehicle information acquired by the device-side communication section.

22. The vehicular display control device according to claim 13, further comprising a device-side communication section configured to acquire vehicle information including at least a piece of information selected from steering information regarding a direction of steering of a steering wheel of the vehicle, gyro sensor information including information on an angle or angular speed of the vehicle, and direction indicator information including information on a direction indicated by a direction indicator,
wherein the display controller ends the display of the display image when a course change or a right or left turn of the vehicle is judged to have finished based on the vehicle information acquired by the device-side communication section in cases where the display image is displayed by the head-up display.

23. The vehicular display control device according to claim 10, further comprising an image processor configured to extract an identical image with an image reflected in a side mirror of the vehicle viewed from the driver.

24. The vehicular display control device according to claim 13, further comprising an image processor configured to extract an identical image with an image reflected in a side mirror of the vehicle viewed from the driver.

25. The vehicular display control device according to claim 13, further comprising a device-side communication section configured to acquire vehicle information including at least a piece of information selected from steering information regarding a direction of steering of a steering wheel of the vehicle, gyro sensor information including information on an angle or angular speed of the vehicle, and direction indicator information including information on a direction indicated by a direction indicator,
wherein the display controller makes the head-up display display the display image of the same side as a direction of a course change or a right or left turn of the vehicle acquired from the vehicle information.
